(19) United States
(12) Patent Application Publication
(10) Pub. No.: US 2014/0300310 A1
(43) Pub. Date: Oct. 9, 2014

(54) PORTABLE QUICK CHARGE BATTERY BOOSTER

(71) Applicant: Magnadyne Corporation, Compton, CA (US)

(72) Inventor: Barry L. Caren, Beverly Hills, CA (US)

(73) Assignee: Magnadyne Corporation, Compton, CA (US)

(21) Appl. No.: 14/108,874

(22) Filed: Dec. 17, 2013

Related U.S. Application Data
(60) Provisional application No. 61/809,725, filed on Apr. 8, 2013.

(51) Int. Cl. H02J 7/00

(52) U.S. Cl. CPC H02J 7/0054
USPC 320/103

(57) ABSTRACT

A portable smart battery booster is needed that can communicate with an electrical or electronic device and adjusts the charging voltage to meet the requirements of electrical or electronic device. A variety of different voltages and currents may be required for different electrical and electronic devices. To facilitate fast charging, smart electrical or electronic devices may desire a higher voltage which is controlled by the smart electrical or electronic device to facilitate a rapid charge mode.

### CROSS-REFERENCE TO RELATED APPLICATIONS

This application claims the benefit of U.S. provisional application Ser. No. 61/809,725 filed Apr. 8, 2013, the disclosure of which is hereby incorporated in its entirety by reference herein.

### TECHNICAL FIELD

This disclosure relates to recharging a battery in a device from a portable back-up battery.

### BACKGROUND

Mobile consumer products such as cell phones, tablet computers, audio players, portable video players, video games and the like use rechargeable batteries. The device battery may be depleted when a device is used extensively. In an effort to address this problem, portable battery packs are available that can provide additional power to recharge the battery of a device after the device's battery is depleted. Vehicle power adapters are also used to recharge device batteries from a vehicle power source that is generally the 12V battery.

It is generally desirable to charge a rechargeable battery as quickly as possible. There are limitations on battery charger designs and on how fast a rechargeable battery can be charged based upon the underlying battery chemistry. For Nickel-based batteries, it is desirable to charge the battery with a constant current source. When using a constant current source, the current applied to the battery can be adjusted to allow for a slow, normal, or fast charge rate. For Lithium-based batteries, it is desirable to have a constant current applied to the battery until the battery reaches full charge. Another charging strategy is to provide the constant current until the battery voltage reaches a threshold voltage and then reducing the charge current. This method requires the input current to be monitored with the charge current being adjusted until the battery is charged.

Battery manufactures specify a stated battery discharge capacity “C” which is measured as a function of current per unit time or more specifically milliampere—hours. This capacity is used to determine the correct charge current and the correct charge time based on an applied current. It also is used to calculate the threshold current at which point the battery is charged. A charging system is specified by the charger output voltage and the maximum allowable current at that output voltage.

Batteries also have a rated operating voltage, if that voltage is exceeded, the battery may malfunction. Electrical and electronic equipment may be designed to operate at a variety of different voltages and currents. Batteries for these electronic devices are configured to support the desired operating voltages and currents. Different operating voltages and currents may be obtained by connecting multiple battery cells in parallel, series or a combination of both.

Available charging devices such as a portable battery, a vehicle power adapter, or AC/DC transformers provide a predetermined level of DC voltage or DC current to recharge the battery of the device. Cell phones have been developed that are capable of changing the voltage received from a charging device to accelerate charging the device's battery from an AC/DC transformer. Currently, there is no convenient way to charge a cell phone from a vehicle power adapter or a battery pack at any voltage other than the predetermined voltage level that provides a normal charging rate.

This disclosure is directed to solving the above problems and other problems as summarized below.

### SUMMARY

A portable smart battery booster is needed that can communicate with an electrical or electronic device and adjusts the charging voltage to meet the requirements of electrical or electronic device. A variety of different voltages and currents may be required for different electrical and electronic devices. To facilitate fast charging, smart electrical or electronic devices may desire a higher voltage which is controlled by the smart electrical or electronic device to facilitate a rapid charge mode.

According to one aspect of this disclosure, the charger communicates with the smart electrical or electronic device in response to communication from the electrical or electronic device. The portable smart battery booster adjusts the charging output voltage to meet the voltage requirements of the smart electrical or electronic device. The portable smart battery booster may communicate with multiple smart devices to allow charging a variety of smart devices from a single portable smart battery booster. This disclosure solves the problem of providing multiple output voltages from a single portable smart battery booster having an internal battery pack.

Another aspect of this disclosure is that the portable smart battery booster output voltage is controlled by either hardware or software.

Another aspect of this disclosure is that the charging power may be provided by a portable battery pack, a DC adapter, or an AC adapter.

A further aspect of this disclosure is that the portable smart battery booster contains an internal battery pack that stores charge that is used to provide the energy to generate the output voltage and current.

The above aspects and other aspects of this disclosure are described below in greater detail with reference to the attached drawings.

### BRIEF DESCRIPTION OF THE DRAWINGS

FIG. 1 is a block diagram of a portable smart battery booster with an integrated internal battery pack where the output voltage is changed via hardware.

FIG. 2 is a block diagram of a portable smart battery booster with an integrated internal battery pack where the output voltage is changed via software.

FIG. 3 is a block diagram of the energy flow from an AC or DC power source to the portable smart battery booster, and then to the smart device.

FIG. 4 is a block diagram of the energy flow from an AC or DC power source to the portable smart battery booster.

FIG. 5 is a block diagram of the energy flow from the portable smart battery booster to the smart device.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

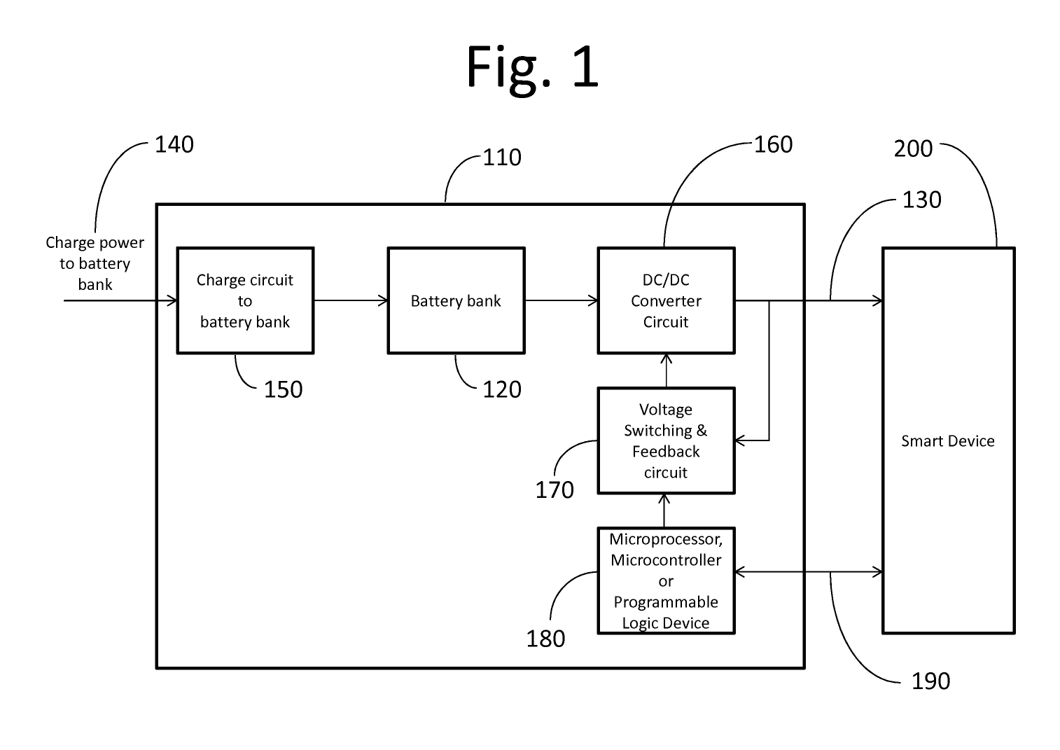

FIG. 1 illustrates a block diagram of a portable smart battery booster 110 with an integrated internal battery pack 120 where an output voltage 130 is changed via hardware. Charge power 140 is supplied to the battery pack 120 by a charge circuit 150. The charge circuit 150 controls the voltage and current applied to the battery pack 120 based on the charge power 140 available and the battery pack 120 state of charge. The charge circuit may consist of a buck or boost converter to generate the required voltage and current. A DC/DC converter circuit 160 converts the battery pack 120 voltage to the desired output voltage 130. The DC/DC converter circuit 160 may utilize a feedback mechanism 170 that monitors the output voltage 130 to increase or decrease the output voltage 130 to maintain the voltage requested. A microprocessor, microcontroller or other programmable logic device 180 is used to communicate with the smart device via a software handshaking 190. This bi-directional communication allows a smart device 200 to send a signal to the portable smart battery booster 110 indicating what voltage output 130 is desired by the smart device.

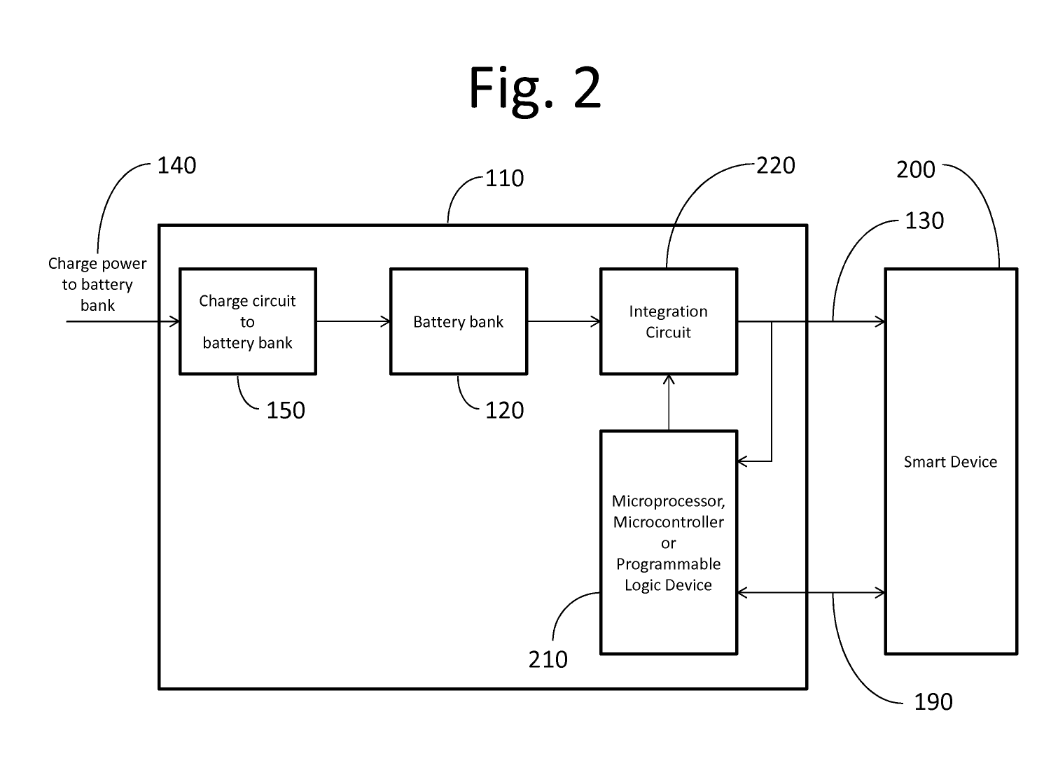

FIG. 2 illustrates a block diagram of the portable smart battery booster 110 with the integrated internal battery pack 120 where the output voltage 130 is changed via software. Charge power 140 is supplied to the battery pack 120 by the charge circuit 150. The charge circuit 150 controls the voltage and current applied to the battery pack 120 based on the charge power 140 available and the battery pack 120 state of charge. The charge circuit may consist of a buck or boost converter to generate the required voltage and current. The DC/DC converter circuit that converts the battery pack 120 voltage to the desired output voltage 130 is accomplished via a pulse width modulation (PWM) signal. The PWM signal is integrated and the integral of the PWM duty cycle is the desired output voltage 130. A microprocessor, microcontroller, or programmable logic device 210 that generates the PWM signal receives feedback from an integration circuit 220. The feedback mechanism monitors the output voltage 130 and microprocessor, microcontroller, or programmable logic device 210 may increase or decrease the PWM duty cycle resulting in an increase or decrease of the output voltage 130 to maintain the voltage requested from the smart device 200. The microprocessor, microcontroller or other programmable logic device 210 is used to communicate with the smart device 200 via a software handshaking 190. This bi-directional communication allows the smart device 200 to send a signal to the portable smart battery booster 110 indicating what voltage output 130 is desired by the smart device.

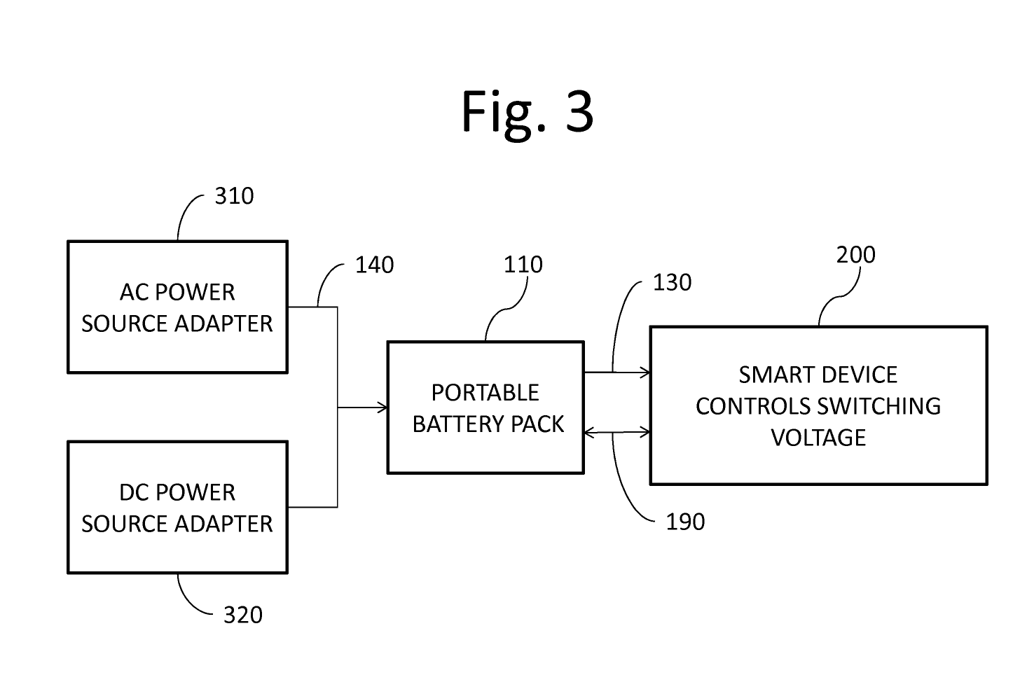

FIG. 3 illustrates a block diagram of the energy flow from an AC power source 310 or a DC power source 320 to the portable smart battery booster 110 with an integrated internal battery pack and then to the smart device 200. The AC power source may consist of standard 50 or 60 Hertz, 110 or 220 volt systems or may be what standard frequency or voltage is available from a utility electrical grid. The AC power source adapter 310 converts the voltage from the utility grid voltage and frequency to the standard voltage 140 accepted by the portable battery pack 110. Likewise, the DC power source 320 will convert the DC voltage to the standard voltage 140 accepted by the portable smart battery booster 110. The portable smart battery booster 110 when connected to the smart device 200, will form a communication link 190. This communication may be unidirectional where the smart device 200 sends a message to the portable smart battery booster 110 to indicate the charging voltage 130. In another embodiment, the communication link 190 may be a bidirectional link where the smart device 200 and the portable smart battery booster 110 send messages back and forth between the two. A bidirectional link allows the portable smart battery booster 110 and smart device 200 to acknowledge that the messages were properly received and confirmed before outputting the required voltage to 130.

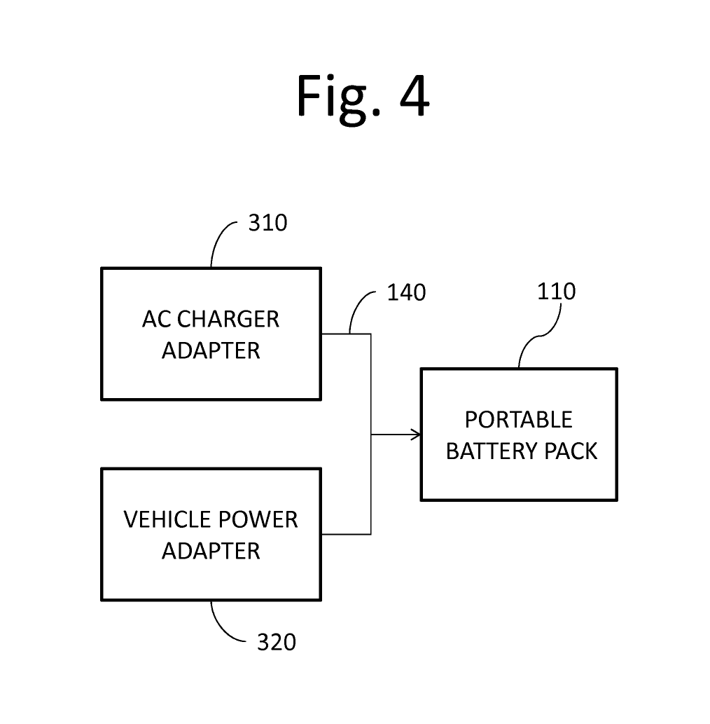

FIG. 4 illustrates a block diagram of the energy flow from the AC power source 310 or the DC power source 320 to the portable smart battery booster 110 with an integrated internal battery pack 120. This illustrates charging the portable smart battery booster 110 with an internal battery pack 120 that may be accomplished separate from the charging of a smart device. The AC power source may consist of standard 50 or 60 Hertz, 110 or 220 volt systems or may be what standard frequency or voltage is available from a utility electrical grid. The AC power source adapter 310 converts the voltage from the utility grid voltage and frequency to the standard voltage 140 accepted by the portable smart battery booster 110. Likewise, the DC power source 320 will convert the DC voltage to the standard voltage 140 accepted by the portable battery pack 110.

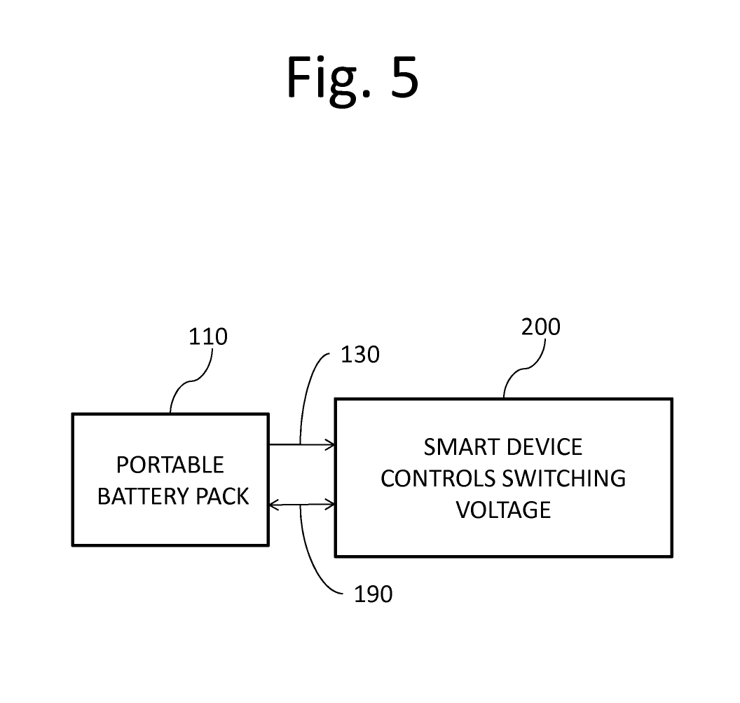

FIG. 5 illustrates a block diagram of the energy flow from the portable smart battery booster 110 with an integrated internal battery pack 120 to a smart device 200. The smart electronic device 200 may be a smart portable cellular phone, a smart portable electronic tablet, a smart electronic game or any electrical device equipped to communicate via the standard used by the communication link 190. The portable smart battery booster 110 includes the internal battery pack 120 that contains the energy that is used to charge a variety of different smart devices 200. This allows a single portable smart battery booster 110 to charge a variety of different smart devices 200, as the smart devices 200 may require different voltages to charge and those voltages will be automatically generated by the portable smart battery booster 110.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A portable power apparatus for charging an electrical device having a rechargeable battery, the apparatus comprising:
an input configured to receive a signal indicative of a desired output voltage from the electrical device;
at least one rechargeable cell having a cell voltage; and
an output configured to provide power from the rechargeable cell to the electrical device at the desired output voltage selected in response to the desired output voltage signal that is different than the cell voltage.

2. The apparatus of claim 1, wherein the input is unidirectional.

3. The apparatus of claim 1, wherein the signal is a digital signal.

4. The apparatus of claim 1, wherein the rechargeable cell is a plurality of rechargeable cells.

5. A portable power pack for charging a battery of a portable electrical device comprising:
a rechargeable cell having a cell voltage;
an output electrically connected with the cell; and
a controller configured to change the output from a battery pack voltage to achieve a desired output voltage different than the cell voltage, selected in response to a signal from the portable electrical device electrically connected with the controller.

6. The portable power pack of claim 5, wherein the rechargeable cell is a plurality of rechargeable cells.

7. The portable power pack of claim 5, wherein the output is generated by a pulse width modulated (PWM) signal.

8. A method for charging an electrical device by a variable voltage portable power pack, the method comprising:
receiving an desired output voltage signal;
selecting an output voltage of a charger from a desired output voltage based on the desired output voltage signal; and
charging the electrical device with energy transferred from the charger at the desired output voltage.

9. The method of claim 8, wherein a DC/DC converter generates an output voltage.
